(19) United States
(12) Patent Application Publication
(10) Pub. No.: US 2023/0229492 A1
(43) Pub. Date: Jul. 20, 2023

(54) AUTOMATED CONTEXT BASED DATA SUBSET PROCESSING PRIORITIZATION

(71) Applicant: International Business Machines Corporation, Armonk, NY (US)

(72) Inventors: Sarbajit K. Rakshit, Kolkata (IN); Pritpal S. Arora, Bangalore (IN); Laxmikantha Sai Nanduru, R K Puram Post (IN)

(21) Appl. No.: 17/648,192

(22) Filed: Jan. 18, 2022

(51) Int. Cl. G06F 9/48

(52) U.S. Cl. CPC G06F 9/4881

(57) ABSTRACT

Disclosed are techniques for dynamically prioritizing subsets of data within datasets based on context. Historical analysis logs, the underlying datasets for the historical analysis logs, and context data are used to train a machine learning model to determine subsets of data within an input dataset when provided the input dataset and a context information input set. When an input dataset and context information input set are received, the machine learning model determines subsets of data (if any) that should be prioritized for processing ahead of other sets of data in the input dataset, based on the context information input set. Subsets of data within an input dataset with higher priority values are processed before other sets of data within the input dataset.

### BACKGROUND

The present invention relates generally to the field of electronic data processing, and more particularly to scheduling data for sequential processing.

Machine learning (ML) refers to the study of computer algorithms which can improve automatically through experience and through the use of data. It is viewed as a part of the field of artificial intelligence. Machine learning algorithms construct a model based on sample data, known as “training data” in order to make predictions or decisions without being explicitly programmed to do so. Machine learning algorithms are leveraged in a wide variety of applications, such as in medicine, email filtering, speech recognition, and computer vision, where it is difficult or unfeasible to develop conventional algorithms to complete the needed tasks.

Explainable artificial intelligence (XAI) is a set of processes and methods that allows human users to comprehend and trust the results and output created by machine learning algorithms. Explainable AI is used to describe an AI model, its expected impact and potential biases. It helps characterize model accuracy, fairness, transparency and outcomes in AI-powered decision making.

DeepLIFT (or Deep Learning Important FeaTures), refers to a technique for decomposing the output prediction of a neural network on a specific input by backpropagating the contributions of all neurons in the network to every feature of the input. DeepLIFT examines differences between the activation of each neuron and its ‘reference activation’ and determines contribution scores according to the difference. By optionally providing separate consideration to negative and positive contributions, DeepLIFT can also reveal dependencies which are overlooked by other approaches. Scores can be efficiently computed through a single backward pass.

In the field of computing, extract, transform, load (ETL) refers to the general procedure of copying data from one or more sources into a destination (or target) system which represents the data differently from the source(s) or in a different context than the source(s). A well designed ETL system extracts data from the source system(s), enforces data quality and consistency standards, conforms data so that separate sources can be used in with one another, and finally delivers data in a presentation-ready format so that application developers can build applications and end users can make decisions and/or analysis on said data. Since the process of data extraction takes time, it is not uncommon to execute the three phases in a pipeline. While the data is being extracted, another transformation process executes elsewhere in the sequence while processing the data already received and prepares it for loading while the data loading begins instead of waiting for the completion of the previous phases. ETL systems frequently integrate data from a plurality of applications (systems), commonly developed and supported by different vendors or hosted on separate computer hardware. The various systems containing the original data are commonly managed and operated by different employees. For example, in a cost accounting system, the ETL procedures may combine data from payroll, sales, and purchasing for unified analysis.

### SUMMARY

According to an aspect of the present invention, there is a method, computer program product and/or system that performs the following operations (not necessarily in the following order): (i) receiving historical user analysis datasets corresponding to historical analysis reports from a set of users on processed historical datasets outputted from a set of machine logic applications, the historical datasets, and a set of context information, with the historical analysis reports having different priority values corresponding to their relative priority based on the set of context information; (ii) generating a machine learning model for determining processing priority values for subsets of data within datasets based on priority values of their corresponding downstream analysis reports and the context information based, at least in part, on the historical user analysis datasets; (iii) receiving an input set of datasets for processing and an input set of context information; (iv) determining, from the set of datasets for processing, at least one subset of data for priority processing based, at least in part, on the machine learning model using the input set of context information as input; and (v) processing the at least one subset of data for priority processing ahead of other datasets of the input set of datasets for processing.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a flowchart showing a second embodiment method.

### DETAILED DESCRIPTION

Some embodiments of the present invention are directed to techniques for dynamically prioritizing subsets of data within datasets based on context. Historical analysis logs, the underlying datasets for the historical analysis logs, and context data are used to train a machine learning model to determine subsets of data within an input dataset when provided the input dataset and a context information input set. When an input dataset and context information input set are received, the machine learning model determines subsets of data (if any) that should be prioritized for processing ahead of other sets of data in the input dataset, based on the context information input set. Subsets of data within an input dataset with higher priority values are processed before other sets of data within the input dataset.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium (sometimes referred to as “machine readable storage medium”) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer’s non-volatile storage and partially stored in a set of semiconductor switches in the computer’s volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

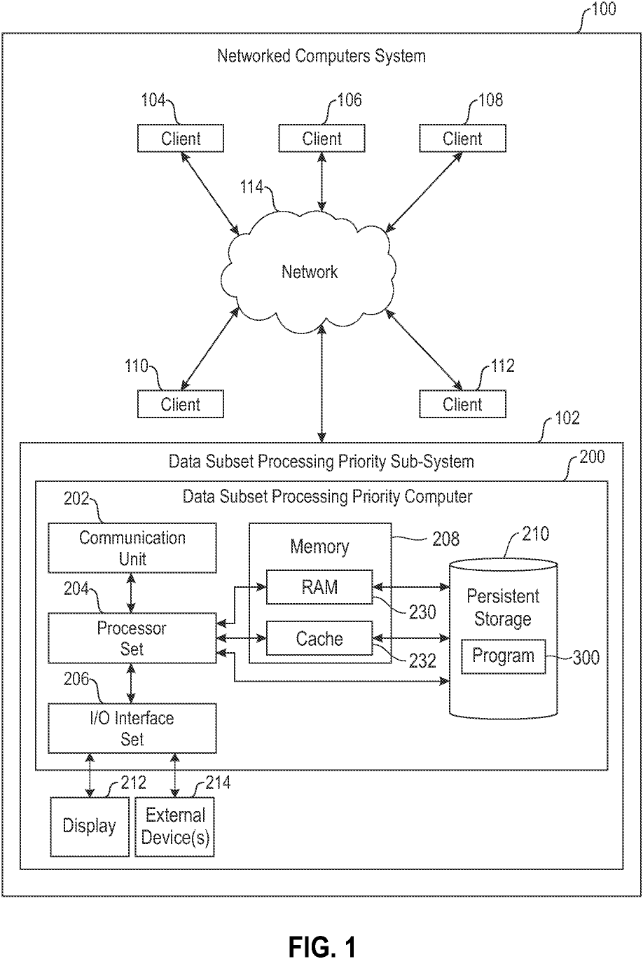

As shown in FIG. 1, networked computers system 100 is an embodiment of a hardware and software environment for use with various embodiments of the present invention. Described in detail with reference to the Figures. Networked computers system 100 includes: data subset processing priority subsystem 102 (sometimes herein referred to, more simply, as subsystem 102); client subsystems 104, 106, 108, 110, 112; and communication network 114. Data subset processing priority subsystem 102 includes: data subset processing priority computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

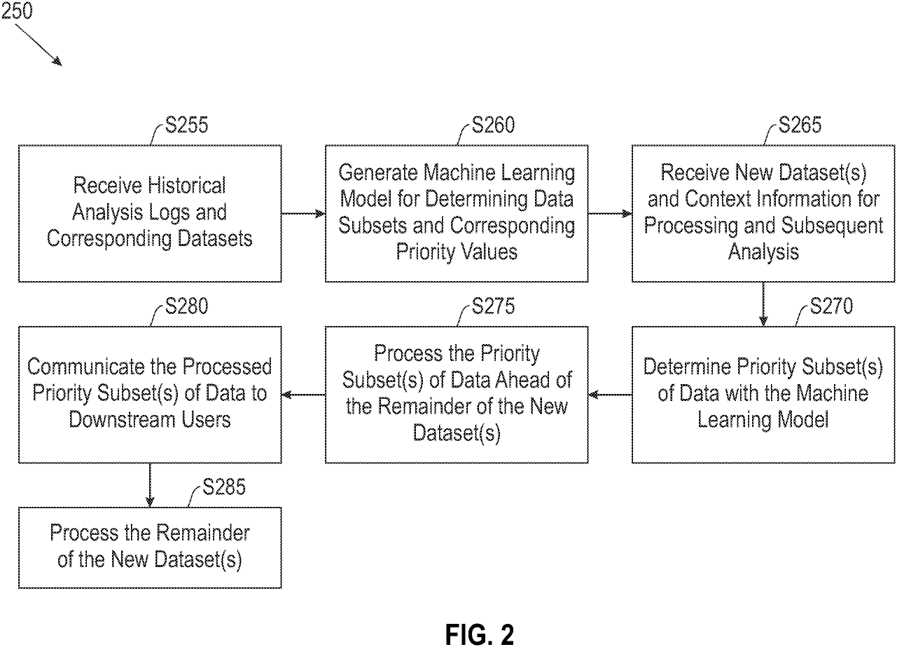

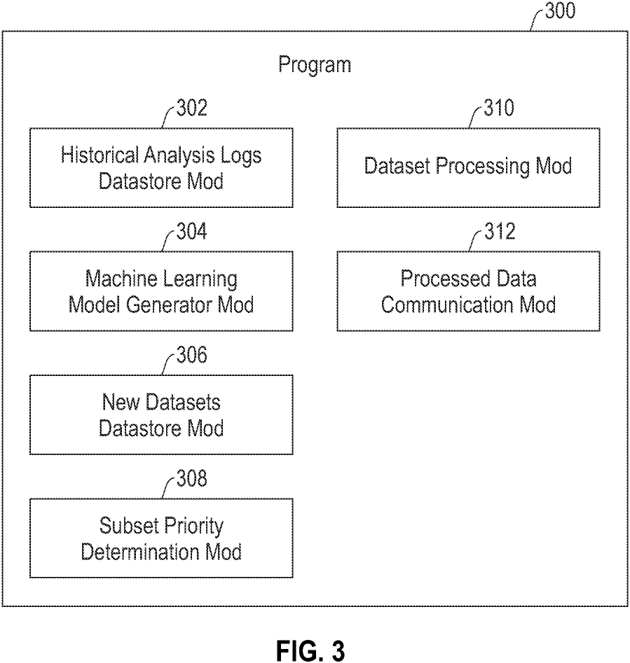

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where historical analysis logs datastore module (“mod”) 302 receives historical analysis logs and corresponding datasets. In this simplified embodiment, the historical analysis logs and corresponding datasets are a plurality of historical analysis logs generated by a variety of business users of Generic Corp through two software applications (Appl and App2) based on 200 historical datasets. Datasets 1 through 75 are generated by Appl hosted on client 104 and datasets 76 through 200 are generated by App2 hosted on client 106. In this simplified embodiment, datasets 50 through 75 from Appl and 76 through 100 from App2 correspond to historical analysis logs with a priority value of 1, indicating that they are the highest priority analysis logs, and the other datasets (datasets 1 through 49 from Appl and 101 through 200 from App2) correspond to historical analysis logs with a priority value of 2, indicating that they are the lowest priority analysis logs.

Processing proceeds to operation S260, where machine learning model generator mod 304 generates a machine learning model for determining data subsets and corresponding priority values. In this simplified embodiment, the machine learning model is generated by training the machine learning model on the historical analysis logs and corresponding datasets stored in historical analysis logs datastore mod 302. The machine learning model is trained by parsing through historical datasets and determining priority values for subsets of data within the historical datasets based on the priority values of their corresponding downstream historical analysis logs and contextual information from natural language processing on e-mails, news feeds, and other context sources. This machine learning model is used to determine filters for segmenting a dataset into subsets for prioritized processing based on an input dataset and context information when sufficient resources are unavailable for parallel processing, and sequential processing must be executed. In some alternative embodiments of the present invention, the machine learning model is also trained to identify referential connections between subsets of data based on metadata structure. For a given context (for example, when nearing the end of a fiscal year, prior to an annual benefits election, or in response to a data breach, geographic regions, or any other types of context information), subsets of data within one or more datasets are determined and assigned priority values indicative of the relative priority of downstream analysis reports or logs that rely on those subsets of data. In this simplified embodiment, when the context includes a data breach within Generic Corp, analysis logs on datasets 50 through 100 are higher priority. Subsets of data and processing priority values are outputted from an input of datasets and context information.

Processing proceeds to operation S265, where new datasets datastore mod 306 receives new dataset(s) and context information for processing and subsequent analysis. In this simplified embodiment, the new dataset(s) include datasets 1 through 200 which have been extracted to a text file for processing, and the context information includes a news article reporting that a data breach has occurred.

Processing proceeds to operation S270, where subset priority determination mod 308 determines priority subset(s) of data with the machine learning model. In this simplified embodiment, the context information and new datasets of 1 through 200 stored in new datasets datastore mod 306 are inputted to the machine learning model which determines that datasets 50 through 100 are a subset of data that have a priority value of 1, indicating that datasets 50 through 100 are to be processed ahead of any datasets with priority values greater than 1 when performing sequential processing on the datasets. The remaining datasets, 1 through 49 and 101 through 200, are assigned a priority value of 2 and grouped together as a subset. In some alternative embodiments, subset priority determination mod 308 analyzes the health and throughput capability available (such as server resources, cloud computing resources, etc.) for processing the dataset(s) received at S265 and first determines if sequential processing is required or if sufficient resources are available that segmenting the data into subsets and processing priority subsets first is unnecessary based on the processing time for processing the entire dataset(s) compared to the priority subsets.

Processing proceeds to operation S275, dataset processing mod 310 processes the priority subset(s) of data ahead of the remainder of the new dataset(s). In this simplified embodiment, the subset with a priority value of 1, datasets 50 through 100, are processed first before datasets 1 through 49 and 101 through 200, resulting in subsets 50 through 100 being available for analysis, now as processed datasets 50 through 100, before the entire dataset of 1 through 200 would be available.

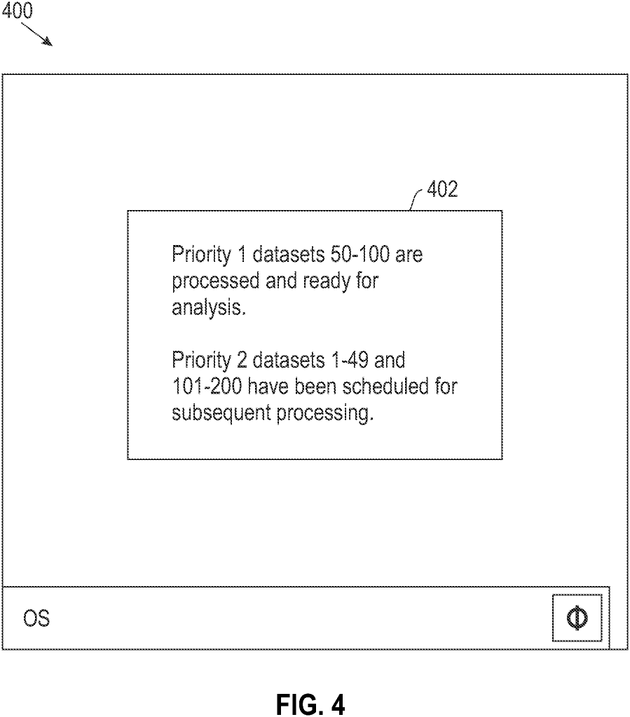

Processing proceeds to operation S280, processed data communication mod 312 communicates the processed priority subset(s) of data to downstream users. In this simplified embodiment, processed datasets 50 through 100 are communicated to client 108, where a business user will run an analysis log called “infosec” on processed datasets 50 through 100. Infosec, short for information security, is a high priority analysis report at Generic Corp when a data breach has been reported, to confirm the extent of the breach and identify any potential impacts and remedies. Also in this simplified embodiment, message 402 of screenshot 400 of FIG. 4 is communicated to client 108 and displayed on a graphical user interface of a computer display device connected to client 108. In some alternative embodiments, message 402 is sent instead (or additionally) to client 112 for monitoring and management of processing priority, where a user may input alternative priorities to manually override the processing priority values assigned to subsets by the machine learning model. When this occurs, the machine learning model collects context information and applies self-learning to refine the machine learning model to determine a new context and subsets with corresponding priority values to be applied in the future when similar context information is inputted.

Processing proceeds to operation S285, dataset processing mod 312 processes the remainder of the new dataset(s). In this simplified embodiment, datasets 1 through 49 and 101 through 200, which were originally excluded from the priority 1 subset by the machine learning model, instead determined to be a subset with a priority of 2, are subsequently processed after the priority 1 subset datasets.

### III. Further Comments and/or Embodiments

Some embodiments of the present invention recognize the following facts, potential problems and/or potential areas for improvement with respect to the current state of the art: (i) in any application landscape, there can be different types of applications; (ii) the applications are talking to each other with upstream and downstream relationship; (iii) data is flowing from one application to another application; (iv) in this case different types of ELT approaches (Extract, load and transformation) the data is loaded from one application to another application; (v) the data is extracted from one source system and is loaded in another target system; (vi) the time required to extract, load and transform the data is dependent on data volume, network load, server health, parallel load etc.; (vii) the data are being analyzed by business users; (viii) the analysis requirement of any business data are dependent on various factors; (ix) for any contextual need, one or more customer or product or geographic location of customer or supplier might become important; (x) the business analyses might want to analyze the data more frequently or as early as possible; (xi) whereas the extracted data will have the entire set of data, and processing of the data will take a longer time, the important customer, product etc. can be a subset of the data; and (xii) so the user has to wait for entire data to process and after that the analysis can be performed, and this can be late.

Some embodiments of the present invention recognize the following facts, potential problems and/or potential areas for improvement with respect to the current state of the art: (i) in the enterprise application landscape, there can be various types of applications that are constantly chatting with each other; (ii) upstream and downstream, and exchanging data among them; (iii) different types of ETL (Extract, Transform & Load) methods may be in use to load data from one application to another; (iv) as the data is extracted from a source system and loaded to the target system, the time required to extract, load and transform the data depends on the volume of data, the network capacity, server capacity, number of parallel loads in progress etc; (v) the data in the target system is analyzed, visualized, reported on by the business users to generate insights; (vi) the processing requirements of business data depends on various factors; (vii) in specific context(s), a customer or product or geographic location or a supplier might be a criterion of higher importance to business, and the business analysts may want to analyze and process the data pertaining to them more frequently or expeditiously, based on the order of priority; (viii) this is especially true for dynamically changing requirements and real-time scenarios; (ix) there is no specific methodology to adapt to changing priorities of data-sets in real-time scenarios; (x) whereas the extracted data contains the entire data collated from multiple sources into a data warehouse or data lake, and the processing of such data with application of transformation rules and filters can take considerable amount of time and considerable effort; (xi) the context and situation might require a subset of data pertaining to a prioritized customer, product or supplier to be processed and analyzed in real-time; (xii) even in streaming analytics and real-time analytics, the concept of obtaining and applying context to transform the data on the fly does not exist today.

Some embodiments of the present invention may include one, or more, of the following operations, features, characteristics and/or advantages: (i) in any application landscape, each and every application will be identifying, and will be identifying the upstream and downstream relationships; (ii) based on extract, load and transformation logic, the proposed technique will identify the data flow trajectory; (iii) the proposed technique will identify the business report analysis log from various business users and identify what types of business data is analyzed; (iv) the proposed technique will identify various contextual systems and will determine the analysis requirements; (v) correlate the various business emails, news information and correlate the analysis needs with various context; (vi) receive manual feedback about the business data analysis and priority context; (vii) determine business data priority context based on historical learning; (viii) determine what types of data are used; (ix) based on historical usage of various business priority analysis, determine what types of filters are used for the analysis; and (x) the identified filters are captured in the knowledge corpus to determine how the data segmentation is done.

Some embodiments of the present invention may include one, or more, of the following operations, features, characteristics and/or advantages: (i) in the enterprise application landscape, every application identify its upstream and downstream relationships with other applications from a data exchange standpoint; (ii) based on the data extract, load and transform logic/method, the proposed technique will determine the data flow trajectory; (iii) parse through the ‘business analysis’ reports/logs for the business users and determine what types of business data is analyzed; (iv) parse through business emails, news inputs, minutes of meetings etc. and correlate prioritized data analysis requirements to various contextual needs; (v) receive manual feeds on the business data analysis requirements and priority context; (vi) Explainable AI matches processing requirements with various ontologies dynamically to determine the priority order of data sets basis the probabilistic ratios/matching scores; (vii) inferring business data processing priority requirements for various subsets of data based on historical learning; (viii) based on historical usage of various business priority analyses and their requirements, determine what types of filters are to be used for processing; (ix) the identified filters are captured in the knowledge corpus to record how the data segmentation is done; and (x) the ETL method extracts data into a text file and then loads the extracted data into various applications in the application landscape.

Some embodiments of the present invention may include one, or more, of the following operations, features, characteristics and/or advantages: (i) capture/store application and data processing logs and determine the time required for processing entire datasets; (ii) determine the referential integrity among the datasets from the metadata structure; (iii) determine priority requirements for various business users and notify them; (iv) business users can also input/specify the business priority; (v) determine comparative priority for different datasets based on the organizational policies or guidelines; (vi) determine what types of filters are to be used for data segmentation based on prioritized processing requirements; (vii) estimate the volume of the filtered data and determine which datasets are to be selected; (viii) determine the associated data from various sources and the subsets of data to be processed; (ix) once the subsets of data are identified based on business priority, clone the existing batch job and assign the subset of data for processing; (x) examine available memory and server resources to decide if non-priority datasets can be processed in parallel, or sequence the processing of other priority subsets of data; (xi) add an identifier in the report indicating which dataset is refreshed and available and which datasets in queue awaiting processing; (xii) adapt, learn and link various probabilistic ratios to newer ontologies as part of continuous learning with DeepLIFT methods; (xiii) DeepLIFT as part of Explanable AI (XAI) and deep learning will compare the activation of each neuron to its ‘reference activation’; and (xiv) assign contribution scores according to the difference with separate consideration to positive and negative contributions for the interpretable ML module.

Some embodiments of the present invention may include one, or more, of the following operations, features, characteristics and/or advantages: (i) enabling Explainable AI (XAI) on the data lake for ETL to generate knowledge-sets and ontologies for the specified domains with deterministic probabilistic learning; (ii) based on the identified contextual priority of the business data analysis requirements, segmenting the extracted data taking into consideration the prioritization criteria; (iii) accordingly creating the required number of child batch jobs to process the priority data so the data refreshment of the priority data can be completed sooner and made available to the business users without keeping them waiting for entire data to be processed; (iv) based on the priority requirement for different sets of business data for various contextual situations, identifying how any larger batch job (which is processing the entire sets of data) can be logically split into multiple child batch jobs to process the subsets of data; (v) determining how the child batch jobs with the subsets of data can be processed (the sequence and level of parallelism of the jobs) so the priority subsets of data can be made available at the earliest; (vi) dynamically updating the reporting dashboard with the refreshment status of various priority subsets of business data; (vii) create notifications about the refreshment of each set of priority data so users can understand at which priority particular dataset is processed; (viii) based on the change in the priority context, dynamically identify the priority data sets and accordingly create new batch jobs for the subsets of data; (ix) terminate old, defunct batch jobs dynamically; (x) based on the historical data analysis patterns, identify other datasets that relate to selected subsets of data and accordingly create appropriate batch jobs to process the subsets of data; (xi) there can be varying levels of priority for different subsets of data; (xii) accordingly considering the volume of subset of data, available database memory etc., and determine how various priority subsets of data are to be processed and non-priority datasets are to be processed so the priority data sets are made available at the earliest; and (xiii) embodiments adapt, learn and link various probabilistic ratios to newer ontologies as part of its continuous learning and explainable AI.

Some embodiments of the present invention may include one, or more, of the following operations, features, characteristics and/or advantages: (i) identifying and generating priority data-sets for Data Extract Transform Load (ETL) scenarios in real-time; (ii) context-aware prioritization of ETL requirements in a big data processing use case; (iii) use Explainable AI (XAI) on the data lake uniquely for ETL to generate knowledge-sets and ontologies for the above use-case; (iv) using segmentation techniques to obtain prioritization data-sets for the batch jobs in ETL scenarios; (v) further, uniquely identifying how large batch jobs may be split into multiple child batch jobs based on the priority requirements for different sets of business data for various contextual situations; (vi) further builds on various priority subsets of business data and generates a unique dashboard of processing jobs and their status, and notifies users; (vii) further outlines techniques to identify changing priorities and accordingly identify priority data-sets and create new batch jobs for extracting them dynamically; (viii) identifying related subsets of data and creating clusters of batch jobs for processing the data in priority; (ix) the volume of the data, database memory etc. as key indicators along-with other constraints and parameters to continuously and dynamically identify and process priority data-sets in real-time scenarios; and (x) continuously adapting, learning and linking various probabilistic ratios to newer ontologies as part of its continuous learning and explainable AI.

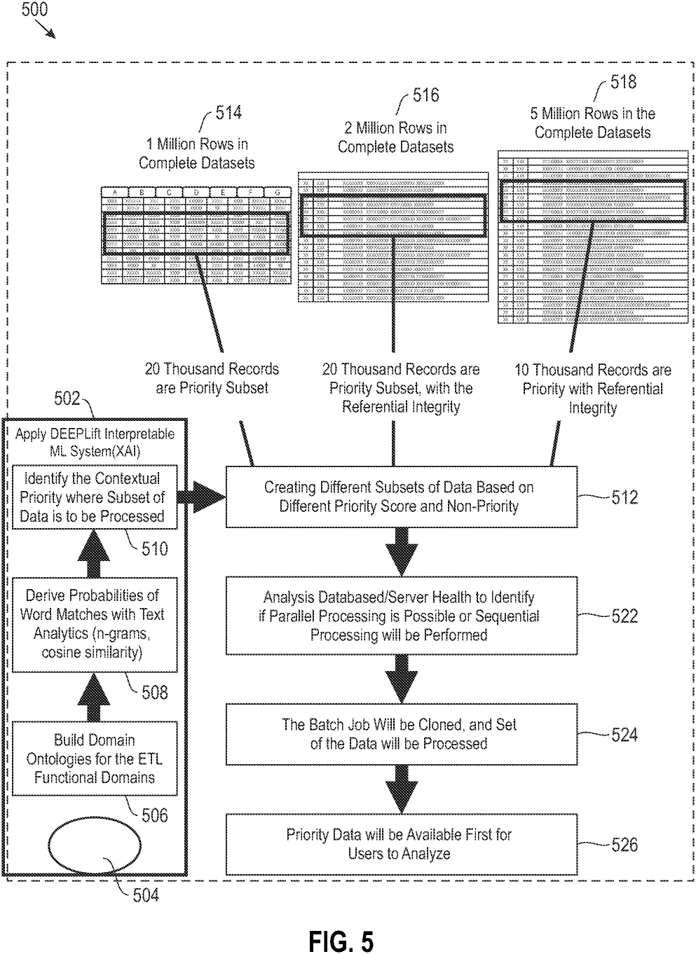

An embodiment of the present invention will now be discussed in reference to FIG. 5. Flowchart 500 of FIG. 5 includes the following: (i) DEEPLift interpretable machine learning (ML) system (also known as explainable AI) 502, including: (a) start block 504, (b) step 508, and (c) step 510; (ii) step 512, which includes subsets of data from: (a) source 514, (b) source 516, and (c) source 518; (iii) step 522; (iv) step 524; and (v) step 526.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

and/or: inclusive or; for example, A, B “and/or” C means that at least one of A or B or C is true and applicable.

In an Including / include / includes: unless otherwise explicitly noted, means “including but not necessarily limited to.”

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

We: this document may use the word “we,” and this should be generally be understood, in most instances, as a pronoun style usage representing “machine logic of a computer system,” or the like; for example, “we processed the data” should be understood, unless context indicates otherwise, as “machine logic of a computer system processed the data”; unless context affirmatively indicates otherwise, “we,” as used herein, is typically not a reference to any specific human individuals or, indeed, and human individuals at all (but rather a computer system).

What is claimed is:

1. A computer-implemented method (CIM) comprising:
receiving historical user analysis datasets corresponding to historical analysis reports from a set of users on processed historical datasets outputted from a set of machine logic applications, the historical datasets, and a set of context information, with the historical analysis reports having different priority values corresponding to their relative priority based on the set of context information;
generating a machine learning model for determining processing priority values for subsets of data within datasets based on priority values of their corresponding downstream analysis reports and the context information based, at least in part, on the historical user analysis datasets;
receiving an input set of datasets for processing and an input set of context information;
determining, from the set of datasets for processing, at least one subset of data for priority processing based, at least in part, on the machine learning model using the input set of context information as input; and
processing the at least one subset of data for priority processing ahead of other datasets of the input set of datasets for processing.

2. The CIM of claim 1, wherein generating the machine learning model further comprises:
parsing the historical analysis reports and the set of context information;
determining which processed historical datasets correspond to which historical analysis reports;
correlating the processed historical datasets to their respective preprocessed historical datasets; and
determining a processing priority value for at least one subset of data from the unprocessed historical datasets and comparing the processing priority value to the priority value of the corresponding historical analysis report in the historical user analysis datasets.

3. The CIM of claim 1, wherein determining at the least one subset of data for priority processing further comprises:
comparing processing time for processing the at least one subset of data to processing the entire input set of datasets; and
determining to apply sequential processing for the input set of datasets, including processing of the subset of data determined for priority processing before other subsets of data of the input set of datasets.

4. The CIM of claim 1, wherein determining at least one subset of data for priority processing further comprises:
determining at least one datasets for inclusion within a given subset of data based, at least in part, on metadata structures indicative of referential integrity between the at least one datasets for inclusion and datasets in the given subset.

5. The CIM of claim 1, further comprising:
communicating a notification to a target computer based, at least in part, on which computer devices receive an analysis report based on the at least one subset of data for priority processing, with the notification including information indicative of prioritization of the at least one subset of data for processing.

6. The CIM of claim 1, wherein the context information includes natural language processing results applied to at least one of: e-mails, news articles, minutes of meetings, and security reports.

7. A computer program product (CPP) comprising:
a machine readable storage device; and
computer code stored on the machine readable storage device, with the computer code including instructions for causing a processor(s) set to perform operations including the following:
receiving historical user analysis datasets corresponding to historical analysis reports from a set of users on processed historical datasets outputted from a set of machine logic applications, the historical datasets, and a set of context information, with the historical analysis reports having different priority values corresponding to their relative priority based on the set of context information,
generating a machine learning model for determining processing priority values for subsets of data within datasets based on priority values of their corresponding downstream analysis reports and the context information based, at least in part, on the historical user analysis datasets,
receiving an input set of datasets for processing and an input set of context information,
determining, from the set of datasets for processing, at least one subset of data for priority processing based, at least in part, on the machine learning model using the input set of context information as input, and
processing the at least one subset of data for priority processing ahead of other datasets of the input set of datasets for processing.

8. The CPP of claim 7, wherein generating the machine learning model further comprises:
parsing the historical analysis reports and the set of context information;
determining which processed historical datasets correspond to which historical analysis reports;
correlating the processed historical datasets to their respective preprocessed historical datasets; and
determining a processing priority value for at least one subset of data from the unprocessed historical datasets and comparing the processing priority value to the priority value of the corresponding historical analysis report in the historical user analysis datasets.

9. The CPP of claim 7, wherein determining at the least one subset of data for priority processing further comprises:
comparing processing time for processing the at least one subset of data to processing the entire input set of datasets; and
determining to apply sequential processing for the input set of datasets, including processing of the subset of data determined for priority processing before other subsets of data of the input set of datasets.

10. The CPP of claim 7, wherein determining at least one subset of data for priority processing further comprises:
determining at least one datasets for inclusion within a given subset of data based, at least in part, on metadata structures indicative of referential integrity between the at least one datasets for inclusion and datasets in the given subset.

11. The CPP of claim 7, wherein the computer code further includes instructions for causing the processor(s) set to perform the following operations:
communicating a notification to a target computer based, at least in part, on which computer devices receive an analysis report based on the at least one subset of data for priority processing, with the notification including information indicative of prioritization of the at least one subset of data for processing.

12. The CPP of claim 7, wherein the context information includes natural language processing results applied to at least one of: e-mails, news articles, minutes of meetings, and security reports.

13. A computer system (CS) comprising:
a processor(s) set;
a machine readable storage device; and
computer code stored on the machine readable storage device, with the computer code including instructions for causing the processor(s) set to perform operations including the following:
receiving historical user analysis datasets corresponding to historical analysis reports from a set of users on processed historical datasets outputted from a set of machine logic applications, the historical datasets, and a set of context information, with the historical analysis reports having different priority values corresponding to their relative priority based on the set of context information,
generating a machine learning model for determining processing priority values for subsets of data within datasets based on priority values of their corresponding downstream analysis reports and the context information based, at least in part, on the historical user analysis datasets,
receiving an input set of datasets for processing and an input set of context information,
determining, from the set of datasets for processing, at least one subset of data for priority processing based, at least in part, on the machine learning model using the input set of context information as input, and
processing the at least one subset of data for priority processing ahead of other datasets of the input set of datasets for processing.

14. The CS of claim 13, wherein generating the machine learning model further comprises:
parsing the historical analysis reports and the set of context information;
determining which processed historical datasets correspond to which historical analysis reports;
correlating the processed historical datasets to their respective preprocessed historical datasets; and
determining a processing priority value for at least one subset of data from the unprocessed historical datasets and comparing the processing priority value to the priority value of the corresponding historical analysis report in the historical user analysis datasets.

15. The CS of claim 13, wherein determining at the least one subset of data for priority processing further comprises:
comparing processing time for processing the at least one subset of data to processing the entire input set of datasets; and
determining to apply sequential processing for the input set of datasets, including processing of the subset of data determined for priority processing before other subsets of data of the input set of datasets.

16. The CS of claim 13, wherein determining at least one subset of data for priority processing further comprises:
determining at least one datasets for inclusion within a given subset of data based, at least in part, on metadata structures indicative of referential integrity between the at least one datasets for inclusion and datasets in the given subset.

17. The CS of claim 13, wherein the computer code further includes instructions for causing the processor(s) set to perform the following operations:
communicating a notification to a target computer based, at least in part, on which computer devices receive an analysis report based on the at least one subset of data for priority processing, with the notification including information indicative of prioritization of the at least one subset of data for processing.

18. The CS of claim 13, wherein the context information includes natural language processing results applied to at least one of: e-mails, news articles, minutes of meetings, and security reports.
